(19) United States
(12) Patent Application Publication
(10) Pub. No.: US 2018/0236559 A1
(43) Pub. Date: Aug. 23, 2018

(54) METHOD OF PRODUCING METAL NANOPARTICLES

(71) Applicants: TOYOTA JIDOSHA KABUSHIKI KAISHA, Toyota-shi (JP); KONAN GAKUEN, Kobe-shi (JP)

(72) Inventors: Junya MURAI, Nisshin-shi (JP); Kensuke AKAMATSU, Nagaokakyo-shi (JP)

(73) Assignees: TOYOTA JIDOSHA KABUSHIKI KAISHA, Toyota-shi (JP); KONAN GAKUEN, Kobe-shi (JP)

(21) Appl. No.: 15/898,405

(22) Filed: Feb. 16, 2018

(30) Foreign Application Priority Data
Feb. 20, 2017 (JP) 2017-029272

(51) Int. Cl. B22F 9/30; C22B 3/00; B01J 19/12

(52) U.S. Cl. CPC B22F 9/30; C22B 11/04; B01J 2219/0877; B22F 2301/255; B01J 2219/1206; B01J 19/126

(57) ABSTRACT

A method of producing metal nanoparticles includes: dissolving an organic metal compound in a non-polar solvent, and mixing a polar solvent with the non-polar solvent to prepare a mixed liquid such that the polar solvent accounts for 5 volume % to 67 volume % of all solvents contained in the mixed liquid; and decomposing the organic metal compound by irradiating the prepared mixed liquid with a microwave, to produce metal nanoparticles. The organic metal compound includes: a non-polar group that is transparent to the microwave and that makes the organic metal compound soluble in the non-polar solvent; and a polar group that is disposed on a site of the organic metal compound, where a metal atom is present, and that absorbs the microwave.

### INCORPORATION BY REFERENCE

The disclosure of Japanese Patent Application No. 2017-029272 filed on Feb. 20, 2017 including the specification, drawings and abstract is incorporated herein by reference in its entirety.

### BACKGROUND

### 1. Technical Field

The disclosure relates to a method of producing metal nanoparticles using microwaves.

### 2. Description of Related Art

There have been proposed methods of producing metal nanoparticles by irradiating a metal compound with microwaves to thermally decompose the metal compound. Such a technique for producing metal nanoparticles is described in, for example, Japanese Unexamined Patent Application Publication No. 2015-059243 (JP 2015-059243 A). JP 2015-059243 A describes a method of producing copper nanoparticles by causing a reaction solution to pass through a pipe irradiated with microwaves. The reaction solution contains: a metal compound containing copper nitrate and copper hydroxide; a polycarboxylic acid serving as a dispersant; dodecane; and a reducing agent.

### SUMMARY

However, with the production method described in JP 2015-059243 A, a portion of the metal compound, which passes through the pipe at a position near an inner wall thereof, is indirectly heated easily due to absorption of the microwaves into the dispersant, whereas another portion of the metal compound, which passes through the pipe at a central portion thereof, is not easily heated. Thus, a reaction of the metal compound proceeds inhomogeneously, that is, the progress of the reaction of the metal compound varies between a position near the inner wall of the pipe and the central portion of the pipe. This leads to a wide range of variations in the particle sizes of the produced metal nanoparticles (copper nanoparticles).

The disclosure provides a method of producing metal nanoparticles, the method allowing a reaction of a metal compound to proceed homogeneously, thereby reducing variations in the particle sizes of the produced metal nanoparticles.

An aspect of the disclosure relates to a method of producing metal nanoparticles. The method includes: dissolving an organic metal compound in a non-polar solvent, and mixing a polar solvent with the non-polar solvent to prepare a mixed liquid such that the polar solvent accounts for 5 volume % to 67 volume % of all solvents contained in the mixed liquid; and decomposing the organic metal compound by irradiating the prepared mixed liquid with a microwave, to produce metal nanoparticles. The organic metal compound includes: a non-polar group that is transparent to the microwave and that makes the organic metal compound soluble in the non-polar solvent; and a polar group that is disposed on a site of the organic metal compound, where a metal atom is present, and that absorbs the microwave.

According to the disclosure, the amount of the polar solvent mixed with the non-polar solvent is appropriately adjusted and the polar group is disposed on the metal atom of the organic metal compound, so that the microwave passes through the non-polar solvent without being absorbed, and the microwave is preferentially absorbed by the polar group of the organic metal compound. Thus, the microwave is efficiently absorbed by the organic metal compound. It is thus possible to alleviate the inhomogeneity of the thermal decomposition reaction of the organic metal compound, thereby reducing variations in the particle sizes of the produced metal nanoparticles.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic sectional view of a microwave synthesizer used in an embodiment of the disclosure;

FIG. 2A is a table illustrating particle size distributions and photographs of gold nanoparticles according to Examples 1 to 3; and

FIG. 2B is a table illustrating particle size distributions and photographs of gold nanoparticles according to Example 4 and Comparative Example 1.

### DETAILED DESCRIPTION OF EMBODIMENTS

Hereinafter, a method of producing metal nanoparticles according to an embodiment of the disclosure will be described. In the present embodiment, first, an organic metal compound is prepared. Specifically, the organic metal compound includes a non-polar group and a polar group. The non-polar group makes the organic metal compound soluble in a non-polar solvent transparent to microwaves. The polar group absorbs microwaves, and is disposed on a site of the organic metal compound, where a metal atom is present.

The metal atoms contained in the molecules of the organic metal compound aggregate into metal nanoparticles after thermal decomposition of the organic metal compound. The kind of the metal atom is not limited to any specific kind, as long as the non-polar group and the polar group are disposed on the metal atom. Examples of the metal atom include gold and silver.

The non-polar group included in the organic metal compound is disposed on a site of the organic metal compound, where the metal atom is present. The non-polar group is transparent to microwaves. The non-polar group makes the organic metal compound soluble in the non-polar solvent. The non-polar group may be a ligand coordinate-bonded to the metal atom.

Examples of the non-polar group include an alkyl group, an aryl group, a cycloalkyl group, a phenyl group, an alkenyl group, an aralkyl group, a cycloalkenyl group, an alkynyl group, an aryl ether group, a silyl group, a siloxanyl group, and an alkoxy group. The non-polar group may be a ligand, such as triphenylphosphine. When the non-polar group is included in the organic metal compound, the organic metal compound can be dispersed and dissolved in the non-polar solvent. In particular, in a case where the non-polar group is a ligand, when the polar group (described below) absorbs microwaves and is separated from the metal atom, the ligand can also be separated from the metal atom.

The polar group included in the organic metal compound is disposed on a site of the organic metal compound, where the metal atom is present. The polar group absorbs microwaves. Examples of the polar group include a hydroxyl group, a carboxylic acid group, a sulfonic acid group, a phosphate group, an acetoxy group, and an amino group. When such a polar group is included in the organic metal compound, microwaves are preferentially absorbed by the polar group, so that a thermal decomposition reaction of the organic metal compound is promoted.

The organic metal compound as described above can be obtained, for example, by preparing a metal salt including a non-polar group and substituting a polar group for an anion of the metal salt. However, the method of producing an organic metal compound is not limited to any specific method, as long as an organic metal compound having the foregoing structure can be produced.

In the present embodiment, a non-polar solvent is prepared next. The non-polar solvent means a solvent with no polarity, in which atoms with substantially the same electronegativity are bonded together so that the electrical charges are evenly distributed. In the present embodiment, the non-polar solvent is transparent to microwaves, and the organic metal compound including the non-polar group dissolves in the non-polar solvent.

Examples of the non-polar solvent include hydrocarbon solvents, such as benzene, toluene, hexane, and heptane. Among these non-polar solvents, it is preferable to use a non-polar solvent that exhibits a dielectric loss factor of 0.1 or less when irradiated with a microwave of 2.45 GHz at room temperature (20° C.).

In the present embodiment, a polar solvent is prepared next. The polar solvent means a solvent with polarity, in which an atom (atoms), such as a heteroatom (heteroatoms) or a halogen atom (halogen atoms), which differ in electronegativity from a carbon atom, are bonded to a carbon atom (carbon atoms) so that the electrical charges are unevenly distributed. In the present embodiment, the polar solvent is a solvent miscible with the non-polar solvent. In the mixed liquid described later, the polar solvent gathers around the polar group of the organic metal compound, so that the polar group and its vicinity in the organic metal compound can be efficiently heated with microwaves.

Examples of the polar solvent include: ether solvents, such as tetrahydrofuran, 1,4-dioxane, and 1,3-dioxolane; ketone solvents, such as acetone, methyl ethyl ketone, and cyclohexanone; ester solvents, such as ethyl acetate, n-butyl acetate, ethyl cellosolve acetate, diethylene glycol monoethyl ether acetate, and propylene glycol monomethyl ether acetate; halogen solvents, such as chloroform, methylene chloride, and 1,2-dichloromethane; and sulfur-containing solvents, such as dimethyl sulfoxide, dimethylsulfone, and tetrahydrothiophene-1,1-dioxide. Among these polar solvents, it is preferable to use a polar solvent that exhibits a dielectric loss factor of 1 or more when irradiated with a microwave of 2.45 GHz at room temperature (20° C.).

In the present embodiment, next, the organic metal compound is dissolved in the non-polar solvent, and the polar solvent is mixed with the non-polar solvent to prepare a mixed liquid such that the polar solvent accounts for 5 vol % (percent by volume) to 67 vol % of all the solvents contained in the mixed liquid. In this way, a mixed liquid containing an organic solvent dissolved in the non-polar solvent can be obtained. The mixed liquid may be prepared by mixing the non-polar solvent and the polar solvent to obtain a mixed solvent first and then dissolving the organic metal compound in the mixed solvent.

When the polar solvent accounts for less than 5 vol % of all the solvents, the polar solvent does not gather around the polar group of the organic metal compound, and thus it is not easy to promote a thermal decomposition reaction of the organic metal compound using microwaves. On the other hand, when the polar solvent accounts for more than 67 vol % of all the solvents, microwaves are easily absorbed by the polar solvent before reaching the organic metal compound. This makes it difficult to cause the organic metal compound to react homogeneously in the mixed liquid, resulting in a wide range of variations in the particle sizes of the produced metal nanoparticles.

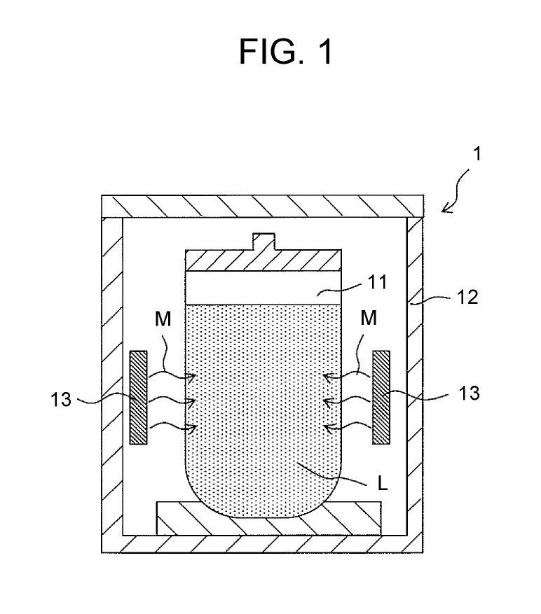

Next, the prepared mixed liquid is introduced into a microwave synthesizer 1 illustrated in FIG. 1. Specifically, a mixed liquid L is introduced into a container 11 transparent to microwaves M, and the mixed liquid L is irradiated with the microwaves M from microwave oscillators 13, 13 disposed in a housing 12. The organic metal compound is thus thermally decomposed to produce metal nanoparticles.

For example, the frequency and output power of the microwaves are not limited to any specific frequency and output power, as long as the organic metal compound can be thermally decomposed to produce metal nanoparticles. For example, the frequency and output power of the microwaves may be experimentally set based on, for example, the amount of the non-polar solvent and the amount of the polar solvent. The frequency of the microwaves may be a frequency at which the microwaves can pass through the non-polar solvent and the non-polar group of the organic metal compound, and the microwaves can be absorbed by the polar group of the organic metal compound.

According to the present embodiment, the amount of the polar solvent mixed with the non-polar solvent is appropriately adjusted and the polar group is disposed on the metal atom of the organic metal compound, so that the microwaves pass through the non-polar solvent in the mixed liquid without being absorbed. The polar solvent gathers around the polar group of the organic metal compound, and the microwaves are preferentially absorbed by the polar group and the polar solvent present around the polar group. It is thus possible to directly heat the sites involved in thermal decomposition, thereby thermally decomposing the organic metal compound efficiently. It is thus possible to alleviate the inhomogeneity of the thermal decomposition reaction of the organic metal compound, thereby reducing variations in the particle sizes of the produced metal nanoparticles.

Hereinafter, examples of the disclosure will be described.

### Example 1

Acetic acid-substituted triphenylphosphine gold was prepared as an organic metal compound. The acetic acid-substituted triphenylphosphine gold includes an acetoxy group as a polar group, and includes triphenylphosphine as a non-polar group. Toluene was prepared as a non-polar solvent, and dimethyl sulfoxide (DMSO) was prepared as a polar solvent. Next, the acetic acid-substituted triphenylphosphine gold was dissolved in the toluene, and the dimethyl sulfoxide (DMSO) was mixed with the toluene in which the acetic acid-substituted triphenylphosphine gold was dissolved, to prepare a mixed liquid.

Specifically, the acetic acid-substituted triphenylphosphine gold was added so that the concentration of the acetic acid-substituted triphenylphosphine gold was 25 mM. The toluene and dimethyl sulfoxide (DMSO) were mixed together in a volume ratio of 19:1 as illustrated in Table 1, and the volume of all the solvents was set to 50 ml. That is, the mixed liquid contains the polar solvent in an amount of 5 vol % with respect to all the solvents.

The acetic acid-substituted triphenylphosphine gold is an organic metal compound represented by the following formula, and can be prepared, for example, by a method described in “In situ template synthesis of one-dimensional gold nanoparticle arrays in organic nanowires”, RSC Adv., 2013, 3, 16243-16246, The Royal Society of Chemistry.

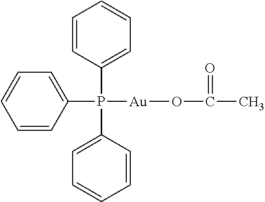

The mixed liquid obtained was introduced into a container transparent to microwaves, and the mixed liquid was irradiated with microwaves at a frequency of 2.45 GHz using a microwave oscillator and heated at 100° C. for 10 minutes. In this way, gold nanoparticles were prepared.

### Example 2

Gold nanoparticles were prepared in a manner similar to that in Example 1. The difference from Example 1 is that toluene and dimethyl sulfoxide (DMSO) were mixed together in a volume ratio of 4:1, as illustrated in Table 1. That is, the mixed liquid contains a polar solvent in an amount of 20 vol % with respect to all the solvents.

### Example 3

Gold nanoparticles were prepared in a manner similar to that in Example 1. The difference from Example 1 is that toluene and dimethyl sulfoxide (DMSO) were mixed together in a volume ratio of 3:1, as illustrated in Table 1. That is, the mixed liquid contains a polar solvent in an amount of 25 vol % with respect to all the solvents.

### Example 4

Gold nanoparticles were prepared in a manner similar to that in Example 1. The difference from Example 1 is that toluene and dimethyl sulfoxide (DMSO) were mixed together in a volume ratio of 1:2 as illustrated in Table 1. That is, the mixed liquid contains a polar solvent in an amount of 67 vol % with respect to all the solvents.

### Comparative Example 1

Gold nanoparticles were prepared in a manner similar to that in Example 1. The difference from Example 1 is that toluene and dimethyl sulfoxide (DMSO) were mixed together in a volume ratio of 1:4, as illustrated in Table 1. That is, the mixed liquid contains a polar solvent in an amount of 80 vol % with respect to all the solvents.

### Comparative Example 2

Copper nanoparticles were prepared by the method described in JP 2015-059243 A. Specifically, copper hydroxide and copper nitrate were dissolved in the same solvent, a polycarboxylic acid serving as a dispersant and diethylene glycol monobutyl ether were mixed with the solution, and hydrazine was further mixed as a reducing agent for a copper salt to prepare a mixed liquid. Then, the mixed liquid was irradiated with microwaves.

Observation of Appearance of Gold Nanoparticles

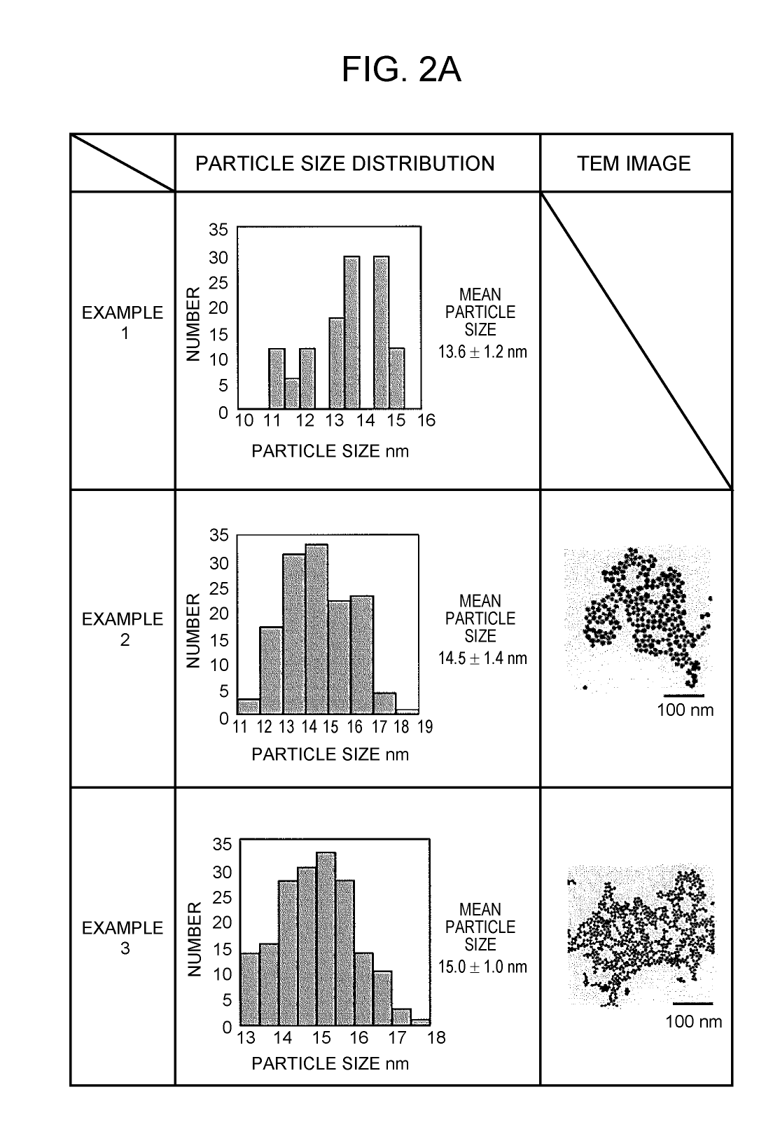

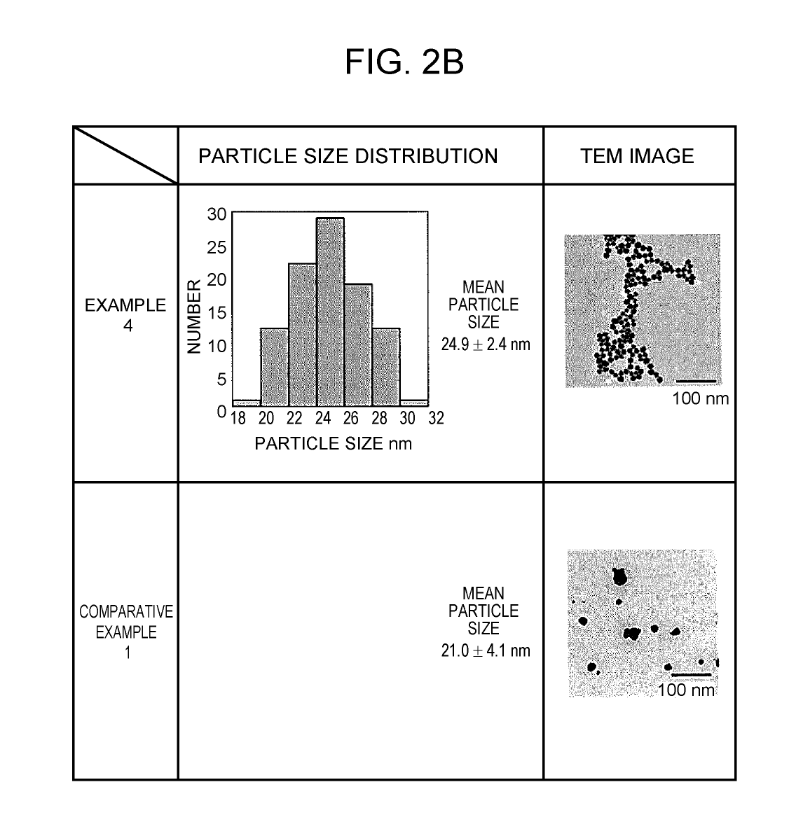

In Examples 1 to 4 and Comparative Example 1, the nanoparticles produced were observed with the use of a transmission electron microscope (TEM). The results are illustrated in FIGS. 2A and 2B. Next, in Examples 1 to 4 and Comparative Examples 1 and 2, the mean particle size of 100 nanoparticles was measured, the number of nanoparticles was measured at each particle size, a standard deviation σ was calculated, and the particle size distribution was calculated as 100× standard deviation σ/mean particle size. The results are illustrated in FIGS. 2A and 2B and Table 1. The variations in the particle sizes were evaluated to be “Small” when the particle size distribution was 10 or less, whereas the variations in particle sizes were evaluated to be “Large” when the particle size distribution was more than 10. The results are illustrated in Table 1.

TABLE 1

| | | Proportion | Mean | | | |
|---|---|---|---|---|---|---|
| | Non-polar | of Polar | Particle | | Particle | Variations |
| | Solvent:Polar | Solvent | Size | Standard | Size | in Particle |
| | Solvent | (vol %) | (nm) | Deviation σ | Distribution | Size |
| Example 1 | 19:1 | 5 | 13.6 | 1.2 | 8.8 | Small |
| Example 2 | 4:1 | 20 | 14.5 | 1.4 | 9.7 | Small |
| Example 3 | 3:1 | 25 | 15.0 | 1.0 | 6.7 | Small |
| Example 4 | 1:2 | 67 | 24.9 | 2.4 | 9.6 | Small |
| Comparative | 1:4 | 80 | 21.0 | 4.1 | 19.5 | Large |
| Example 1 | | | | | | |

| | | | | | |
|---|---|---|---|---|---|
| Comparative | — | — | — | 20 or more | Large |
| Example 2 | | | | | |

Results and Consideration

As illustrated in FIGS. 2A and 2B and Table 1, the variations in the particle sizes of the gold nanoparticles in each of Examples 1 to 4 were smaller than those of the nanoparticles in each of Comparative Examples 1 and 2. It is considered that, in each of Examples 1 to 4, the proportion of the non-polar solvent is higher than that in Comparative Example 1, and therefore the microwaves passing through the non-polar solvent easily reach a portion of the mixed liquid, which is present at and near the central portion of the container (hereinafter, referred to as “inner portion of the mixed liquid in the container”), and the microwaves are preferentially absorbed by the acetoxy group that is the polar group in the acetic acid-substituted triphenylphosphine gold. It is therefore considered that the microwaves are likely to be more homogeneously absorbed by the acetic acid-substituted triphenylphosphine gold dispersed in the mixed liquid.

In this process, the acetoxy group that is the polar group is separated from a gold atom, and thus triphenylphosphine that is the non-polar group (ligand) is also separated from the gold atom. Thus, the microwaves are preferentially absorbed by the acetoxy group that is the polar group in the acetic acid-substituted triphenylphosphine gold, so that the acetic acid-substituted triphenylphosphine gold can be thermally decomposed efficiently. It is therefore considered that, in each of Examples 1 to 4, a thermal decomposition reaction of the acetic acid-substituted triphenylphosphine gold occurred homogeneously also in the inner portion of the mixed liquid in the container, resulting in a narrow particle size distribution and small variations in the particle sizes of the gold nanoparticles.

On the other hand, it is considered that, in Comparative Example 1, the proportion of the polar solvent is higher than that in Examples 1 to 4, and therefore the polar solvent is more easily heated by the microwaves, and the microwaves do not sufficiently reach the acetic acid-substituted triphenylphosphine gold in the inner portion of the mixed liquid in the container. Thus, the microwaves cause uneven temperature distribution of the mixed liquid, that is, the temperature of the mixed liquid varies between a position near the inner wall surface of the container and the inner portion (at and near the central portion) of the container. It is therefore considered that, in Comparative Example 1, the thermal decomposition reaction of the acetic acid-substituted triphenylphosphine gold was so inhomogeneous that the gold nanoparticles in Comparative Example 1 had a broader particle size distribution and larger variations in particle size than the nanoparticles in Examples 1 to 4.

In Comparative Example 2 as well, the metal compound (copper compound) is not easily heated directly by the microwaves, while the solvent is easily heated by the microwaves. Thus, like in Comparative Example 1, the thermal decomposition reaction of the copper compound occurs inhomogeneously. As a result, it is considered that the copper nanoparticles in Comparative Example 2 had a broader particle size distribution and larger variations in particle size than the nanoparticles in Examples 1 to 4.

Although the example embodiment of the disclosure has been described in detail, the specific configurations are not limited to the foregoing embodiment and examples. Modifications made without departing from the technical scope of the disclosure are included in the scope of the disclosure.

What is claimed is:

1. A method of producing metal nanoparticles, the method comprising:
dissolving an organic metal compound in a non-polar solvent, and mixing a polar solvent with the non-polar solvent to prepare a mixed liquid such that the polar solvent accounts for 5 volume % to 67 volume % of all solvents contained in the mixed liquid; and
decomposing the organic metal compound by irradiating the prepared mixed liquid with a microwave, to produce metal nanoparticles,
wherein the organic metal compound includes
a non-polar group that is transparent to the microwave and that makes the organic metal compound soluble in the non-polar solvent, and
a polar group that is disposed on a site of the organic metal compound, where a metal atom is present, and that absorbs the microwave.

2. The method according to claim 1, wherein the non-polar solvent is transparent to the microwave.

3. The method according to claim 1, wherein the polar group and the non-polar group are coordinate-bonded to the metal atom.

4. The method according to claim 1, wherein the microwave has a frequency at which the microwave passes through the non-polar solvent and the non-polar group of the organic metal compound and the microwave is absorbed by the polar group of the organic metal compound.

5. The method according to claim 1, wherein
the non-polar solvent is transparent to the microwave,
the polar group and the non-polar group are coordinate-bonded to the metal atom, and
the microwave has a frequency at which the microwave passes through the non-polar solvent and the non-polar group of the organic metal compound and the microwave is absorbed by the polar group of the organic metal compound.
